(19) United States
(12) Patent Application Publication
(10) Pub. No.: US 2008/0192422 A1
(43) Pub. Date: Aug. 14, 2008

(54) SYSTEM MANAGEMENT PROTECTION DEVICE FOR SERVER

(75) Inventor: Cheng-Hua Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INVENTEC CORPORATION, Taipei City (TW)

(21) Appl. No.: 11/674,160

(22) Filed: Feb. 13, 2007

(51) Int. Cl. G06F 1/16; H01R 12/16

(52) U.S. Cl. 361/683; 361/788

(57) ABSTRACT

A server including a backplane, first and second EM units is provided. The signal of the first EM unit is determined whether or not to be transmitted to a bus at the backplane according to statuses of the first EM unit and other EM unit(s). The signal of the second EM unit is determined whether or not to be transmitted to the bus according to statuses of the second EM unit and other EM unit(s). Thus, the server prevents the first and the second EM units on the backplane simultaneously connected to the backplane to cause a signal short between the first and the second EM units.

### BACKGROUND OF THE INVENTION

1. Field of the Invention

The present invention relates to a system management protection device of a server. More particularly, the present invention relates to a system management protection device for a server, for connecting the first or the second enclosure management (EM) unit in the server to a backplane of the server.

2. Description of Related Art

With the increasing expansion of information flow, many enterprises gradually integrate their servers to a centralized data center and also integrate a plurality of small servers distributed everywhere in the enterprises into one place, so as to reduce the high cost and difficulty caused by the dispersed management, thereby forming a new-style server, which is called a blade server. The blade server has the advantages of small volume, space saving, easy to manage, a low cost, and rapid architecture, and is compatible with different operating systems. The blade server integrates a processor, a memory, and a hard disk onto a single motherboard, so as to form a motherboard with server system functions. Each of the motherboards is called one server blade, and the server blades are installed on a backplane and share one chassis, power supply, keyboard, mouse, and display.

In order to manage the shared resources, two EM boards (EM) are mounted on the backplane of the blade server, in which one EM is active and the other EM is redundant. In this manner, if the active EM is broken down or damaged, the redundant EM will be switched into the active EM instantly to protect the system, such that the system may still manage the entire operation of the blade server during the breakdown and damage of the active EM. The active EM and the redundant EM usually have independent circuits respectively, and now in order to save space, the circuits of the two are integrated into one. In the blade server, the active EM and the redundant EM are both directly connected to the backplane via a bus. When the main EM is damaged, the connection between the main EM and the backplane bus cannot be efficiently cut off, resulting in the crosstalk of signals of the main and redundant EMs, thus leading to false actions of the circuit and further damaging the chips or circuits in the EMs.

Therefore, it is an urgent problem to be solved in the art how to provide a new system management protection device for a server, capable of instantly cutting off the connection signal between the main EM and the redundant EM when the main EM in the server malfunctions, so as to prevent a signal short occurring in the server.

### SUMMARY OF THE INVENTION

The present invention provides a server, in which one of a first and a second EM units is connected to a bus of a backplane, and the other one is disconnected with the bus, so as to prevent the crosstalk of the signals of the first and the second EM units and to prevent burning chips or circuits in a management unit due to false actions of the circuit in the management unit.

In order to solve the aforementioned problems, the present invention provides a server, which includes a backplane, a first EM unit, and a second EM unit. The first EM unit includes a first switch unit and a first protect-control unit. The first switch unit is connected to the backplane through a bus, so as to determine whether or not to allow a signal of the first EM unit to be transmitted to the bus through the first switch unit according to a first switch signal. The first protect-control unit outputs the first switch signal and determines an enable status of the first switch signal according to statuses of the first EM unit and other EM units. The second EM unit includes a second switch unit and a second protect-control unit. The second switch unit is connected to the backplane through the bus, so as to determine whether or not to allow a signal of the second EM unit to be transmitted to the bus through the second switch unit according to a second switch signal. The second protect-control unit outputs the second switch signal, and determines an enable status of the second switch signal according to statuses of the second EM unit and other EM units.

In the present invention, the first EM unit and the second EM unit are operated by each other to control the switch unit therein to be turned on or turned off, so as to determine the connection relation between the first EM unit and the bus and determine the connection relation between the second EM unit and the bus. As such, either the first EM unit or the second EM unit is in an active EM unit status. That is to say, when accidents occur and cause the first EM unit and the second EM unit both in the active EM unit status, the present invention can prevent the first and the second EM units connected to the bus simultaneously, thereby preventing the unreliable operation resulting form the burning of the circuit or even the breakdown of the server caused by the signal short.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of the basic architecture of a server according to an embodiment of the present invention.

FIG. 2 shows the first protect-control unit in FIG. 1 according to an embodiment of the present invention.

FIG. 3 shows the first protect-control unit in FIG. 1 according to an embodiment of the present invention.

### DESCRIPTION OF EMBODIMENTS

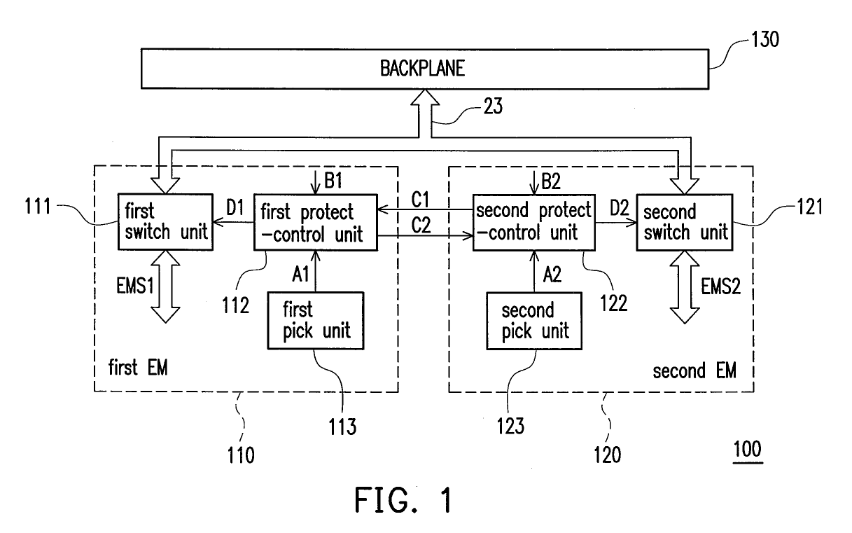

FIG. 1 is a block diagram of the basic architecture of a server according to an embodiment of the present invention. As shown in FIG. 1, a first EM unit 110, a second EM unit 120, and other module units (not shown) of the server 100 are all connected to a backplane 130 through a bus 23. The bus 23 can be a universal serial bus (USB) or a bus of another type. The first EM unit 110 of server 100 includes a first switch unit 111, a first protect-control unit 112, and a first pick unit 113, and the second EM unit 120 includes a second switch unit 121, a second protect-control unit 122, and a second pick unit 123.

The first switch unit 111 and the second switch unit 121 are connected to the backplane 130 through the bus 23. The first switch unit 111 determines whether or not to allow a signal EMS1 of the first EM unit 110 to be transmitted to the bus 23 through the first switch unit 111 according to a first switch signal D1 of the first protect-control unit 112. The signal EMS1 indicates that an internal circuit (not shown) of the first EM unit 110 is to access the bus 23. Similarly, the second switch unit 121 determines whether or not to allow a signal EMS2 of the second EM unit 120 to be transmitted to the bus 23 through the second switch unit 121 according to a second switch signal D2 output by the second protect-control unit 122. The signal EMS2 indicates an internal circuit (not shown) of the second EM unit 120 is to access the bus 23. In this embodiment, when the switch signal D1 (or D2) is logic 0, the switch unit 111 (or 121) is turned on and when the switch signal D1 (or D2) is logic 1, the switch unit 111 (or 121) is turned off.

The first pick unit 113 is used to pick up a status of the first EM unit 110 and output a first status message A1 accordingly. The second pick unit 123 is used to pick up a status of the second EM unit 120 and output a second status message A2 accordingly. The status message A1 or A2 indicates that the EM unit 110 or 120 is in an active or an inactive status, respectively. In this embodiment, when the status message A1 (or A2) is logic 0, it indicates that the EM unit 110 (or 120) is an active EM unit. When the status message A1 (or A2) is logic 1, it indicates that the EM unit 110 (or 120) is an inactive EM unit.

The first protect-control unit 112 determines an enable status of the first switch signal D1 according to statuses of the first EM unit 110 and other EM units (for example, the EM unit 120). The second protect-control unit 122 determines an enable status of the second switch signal D2 according to statuses of the second EM unit 120 and other EM units (for example, the EM unit 110). In this embodiment, the protect-control unit 122 outputs a first notification message C1 to the protect-control unit 112 and the notification message C1 indicates a status of the second EM unit 120. The protect-control unit 112 determines the level of the first switch signal D1 according to a first default level setting B1, the first status message A1, and the logic status of the first notification message C1.

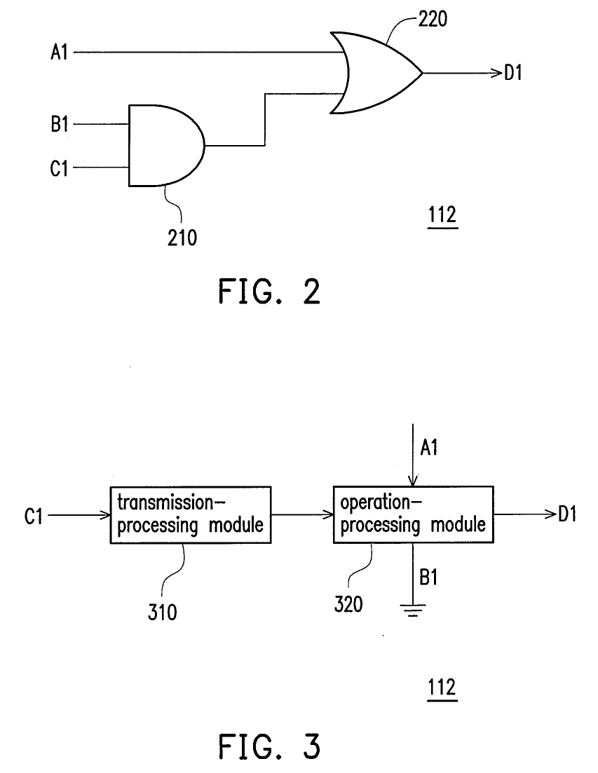

Herein, in the first default level setting B1, logic 0 indicates a main EM unit and logic 1 indicates a secondary EM unit. In this embodiment, the first default level setting B1 can be grounded to set the EM unit 110 as the main EM unit. Additionally, if the first notification message C1 is logic 1, it indicates that the status of the second EM unit 120 is an active EM unit. Otherwise, if the first notification message C1 is logic 0, it indicates that the status of the second EM unit 120 is an inactive EM unit. Therefore, the first protect-control unit 112 can be realized according to a truth table of Table 1. FIG. 2 shows the first protect-control unit 112 according to an embodiment of the present invention. In Table 1, the protect-control unit 112 can be realized by using an AND gate 210 and an OR gate 220.

TABLE 1
Truth Table of First Protect-Control Unit 112

| | | Notification | |
|---|---|---|---|
| Status Message A1 | Level Setting B1 | Message C1 | Switch Signal D1 |
| 0 | 0 | 0 | 0 |
| 0 | 0 | 1 | 0 |
| 0 | 1 | 0 | 0 |
| 0 | 1 | 1 | 1 |
| 1 | 0 | 0 | 1 |
| 1 | 0 | 1 | 1 |
| 1 | 1 | 0 | 1 |
| 1 | 1 | 1 | 1 |

FIG. 3 shows another embodiment of the first protect-control unit 112 in FIG. 1. The first protect-control unit 112 includes a first transmission-processing module 310 and a first operation-processing module 320. The operation-processing module 320 receives the first notification message C1 transmitted by the second protect-control unit 122 through the first transmission-processing module 310, so as to acquire the status of the second EM unit 120. The first operation-processing module 320 operates and processes according to the first default level setting B1, the first status message A1, and the first notification message C1, so as to generate the first switch signal D1. In this embodiment, the operation-processing module 320 performs mathematical calculations according to Boolean expression D1=A1+B1·C1. Therefore, the first operation-processing module 112 can include a first AND gate and a first OR gate. A first input end and a second input end of the first AND gate receive the first default level setting B1 and the first notification message C1, respectively. A first input end and a second input end of the first OR gate receive the output of the first AND gate and the first status message A1, respectively, so as to output the first switch signal D1.

Referring to FIG. 1, the protect-control unit 122 can be realized according to a truth table of Table 2. The implementation method of the protect-control unit 122 is similar to that of the protect-control unit 112 and will not be repeated herein.

TABLE 2
Truth Table of Second Protect-Control Unit 122

| | | Notification | |
|---|---|---|---|
| Status Message A2 | Level Setting B2 | Message C2 | Switch Signal D2 |
| 0 | 0 | 0 | 0 |
| 0 | 0 | 1 | 0 |
| 0 | 1 | 0 | 0 |
| 0 | 1 | 1 | 1 |
| 1 | 0 | 0 | 1 |
| 1 | 0 | 1 | 1 |
| 1 | 1 | 0 | 1 |
| 1 | 1 | 1 | 1 |

From Tables 1 and 2, when the server 100 detects that the first EM unit 110 is in an active status (i.e., the status message A1 is logic 0, and the notification message C2 is logic 1) and the server 100 detects that the second EM unit 120 is in a inactive status (i.e., the status message A2 is logic 1, and the notification message C1 is logic 0), the first switch signal D1 is logic 0 and the second switch signal D2 is logic 1. At this time, the switch unit 111 is controlled by the switch signal D1 to be turned on, such that the first EM unit 110 is connected to the bus 23 on the backplane 130 through the switch unit 111. The switch unit 121 is controlled by the switch signal D2 to be turned off, such that the second EM unit 120 is disconnected with the bus 23 on the backplane 130.

When the server 100 detects that the first EM unit 110 is in an active status (i.e., the status message A1 is logic 1, and the notification message C2 is logic 0) and the server 100 detects that the second EM unit 120 is in a inactive status (i.e., the status message A2 is logic 0, and the notification message C1 is logic 1), the first switch signal D1 is logic 1 and the second switch signal D2 is logic 0. At this time, the switch unit 121 is controlled by the switch signal D2 to be turned on, such that the second EM unit 120 is connected to the bus 23 on the backplane 130 through the switch unit 121. The switch unit 111 is controlled by the switch signal D1 to be turned off, such that the first EM unit 110 is disconnected with the bus 23 on the backplane 130.

When the status message A1 of the first EM unit 210 is logic 0 and the notification message C1 is logic 1. It can be known from the above that the first EM unit 110 and the second EM unit 120 in such a status are both in an active status. At this time, the protect-control unit 112 switches the switch signal D1 to be logic 0 according to the default level setting B1; and the protect-control unit 122 switches the switch signal D2 to be logic 1 according to the default level setting B2 (for example, presetting the level setting B2 as logic 1). At this time, the switch unit 111 is controlled by the switch signal D1 to be turned on. The switch unit 121 is controlled by the switch signal D2 to be turned off. Therefore, this embodiment may solve the defect that the server malfunctions when the first EM unit 110 and the second EM unit 120 are both in an active status, so as to further avoid the problem that the server cannot run effectively, and even the internal circuit of the server is burned and the server is broken down when the first and second EM units in an active status in the conventional server without any protection mechanism are both connected to the bus on the backplane due to a signal short.

Furthermore, as shown in Table 1, when the status message A1 of the first EM unit 110 is logic 1 and the notification message C1 is logic 0 (i.e., the first EM unit 110 and the second EM unit 120 are both in a inactive status), the first switch signal D1 and the second switch signal D2 are both logic 1, such that the switch unit 111 and 121 are both in a turn-off status. Therefore, the first EM unit 110, the second EM unit 120, and the bus 23 on the backplane 130 are not connected, which indicates that the server 100 is abnormal. At this time, an alert signal is sent through the server 100 for a server maintenance staff to maintain the server accordingly, such that the server 100 may run reliably and stably which is known persons in the art and is not the characteristic of the present invention, so it will not be repeated herein again.

In view of the above, in the server 100 in the aforementioned embodiments, the switch units 111 and 121 are controlled to be turned on/off mainly through the mutual operation of the protect-control units 112 and 122, such that the first EM unit 110 or the second EM unit 120 are connected to the bus 23 on the backplane 130 through the corresponding switch unit 111 or 121. Therefore, through the aforementioned embodiments, only one of the first EM unit 110 and the second EM unit 120 is connected to the bus 23 on the backplane 130 through the corresponding switch unit (111 or 121), so the first EM unit and the second EM unit will not be connected to the bus on the backplane simultaneously. In addition, in the aforementioned embodiments, when the first EM unit or the second EM unit becomes abnormal, the abnormal one is prevented from being connected to the bus on the backplane, such that the first EM unit or the second EM unit will not suffer the crosstalk and short of signals due to the bus on the backplane. Due to the crosstalk of signals, the internal circuit in the server may easily suffer a short circuit and then is burned, and even the server may be broken down and cannot run reliably.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A server, comprising:
a backplane;
a first enclosure management (EM) unit, comprising:
a first switch unit, connected to the backplane through a bus and used to determine whether or not to allow a signal of the first EM unit to be transmitted to the bus through the first switch unit according to a first switch signal; and
a first protect-control unit, for outputting the first switch signal and determining an enable status of the first switch signal according to statuses of the first EM unit and other EM units; and
a second EM unit, comprising:
a second switch unit, connected to the backplane through the bus and used to determine whether or not to allow a signal of the second EM unit to be transmitted to the bus through the second switch unit according to a second switch signal; and
a second protect-control unit, for outputting the second switch signal and determining an enable status of the second switch signal according to statuses of the second EM unit and other EM units.

2. The server as claimed in claim 1, wherein the first EM unit further comprises:
a first pick unit, for picking up a first status message of the first EM unit and outputting the first status message to the first protect-control unit, wherein the first status message indicates that the first EM unit is in an active status or an inactive status.

3. The server as claimed in claim 1, wherein the first protect-control unit comprises:
a first transmission-processing module, for receiving a first notification message transmitted by the second protect-control unit, wherein the first notification message indicates a status of the second EM unit; and
an operation-processing module, for operating and processing according to a first default level setting, a first status message, and the first notification message, so as to generate the first switch signal, wherein the first status message indicates that the first EM unit is an active or inactive EM unit.

4. The server as claimed in claim 3, wherein the first default level setting uses logic 0 to indicate a main EM unit and logic 1 to indicate a secondary EM unit.

5. The server as claimed in claim 3, wherein the first status message uses logic 0 to indicate an active EM unit and logic 1 to indicate an inactive EM unit.

6. The server as claimed in claim 3, wherein the first notification message uses logic 1 to indicate that the status of the second EM unit is an active EM unit and logic 0 to indicate that the status of the second EM unit is an inactive EM unit.

7. The server as claimed in claim 3, wherein the first switch signal uses logic 0 to indicate that the first switch unit is turned on and logic 1 to indicate that the first switch unit is turned off.

8. The server as claimed in claim 1, wherein the first protect-control unit comprises:
a first AND gate, having a first input end and a second input end receiving a first default level setting and a first notification message transmitted by the second protect-control unit, respectively; and
a first OR gate, having a first input end and a second input end receiving the output of the first AND gate and a first status message respectively, so as to output the first switch signal;
wherein the first status message indicates that the first EM unit is an active or inactive EM unit.

9. The server as claimed in claim 1, wherein the second EM unit further comprises:
a second pick unit, for picking up a second status message of the second EM unit and outputting the second status message to the second protect-control unit, wherein the second status message indicates that the second EM unit is in an active or inactive status.

10. The server as claimed in claim 1, wherein the second protect-control unit comprises:
a second transmission-processing module, for receiving a second notification message transmitted by the first protect-control unit, wherein the second notification message indicates the status of the first EM unit; and
a second operation-processing module, for operating and processing according to a second default level setting, a second status message, and the second notification message, so as to generate the second switch signal, wherein the second status message indicates that the second EM unit is an active or inactive EM unit.

11. The server as claimed in claim 10, wherein the second default level setting uses logic 0 to indicate a main EM unit and logic 1 to indicate a secondary EM unit.

12. The server as claimed in claim 10, wherein for the second status message, logic 0 indicates an active EM unit and logic 1 indicates a inactive EM unit.

13. The server as claimed in claim 10, wherein for the second notification message, logic 1 indicates that the status of the first EM unit is an active EM unit and logic 0 indicates that the status of the first EM unit is a inactive EM unit.

14. The server as claimed in claim 10, wherein for the second switch signal, logic 0 indicates that the second switch unit is turned on and logic 1 indicates that the second switch unit is turned off.

15. The server as claimed in claim 1, wherein the second protect-control unit comprising:
a second AND gate, having a first input end and a second input end receive a second default level setting and a second notification message transmitted by the first protect-control unit, respectively; and
a second OR gate, having a first input end and a second input end receive the output of the second AND gate and a second status message, respectively, so as to output the second switch signal;
wherein the second status message indicates that the second EM unit is an active or inactive EM unit.
